(19) United States
(12) Patent Application Publication
(10) Pub. No.: US 2018/0021935 A1
(43) Pub. Date: Jan. 25, 2018

(54) SHELL HANDLE AND METHOD OF FABRICATION THEREOF

(71) Applicant: GARANT GP, SAINT-FRANÇOIS (CA)

(72) Inventors: CARL BLOUIN, LÉVIS (CA); PATRICK JULIEN, LÉVIS (CA); DAVID BOIES, LÉVIS (CA)

(21) Appl. No.: 15/597,536

(22) Filed: May 17, 2017

Related U.S. Application Data
(60) Provisional application No. 62/363,903, filed on Jul. 19, 2016.

(51) Int. Cl. B25G 1/00

(52) U.S. Cl. CPC B25G 1/00; B60S 3/045

(57) ABSTRACT

A handle and a method of fabrication thereof, the handle, comprising a first shell and a second shell, the first shell comprising, on an inner surface thereof, a first longitudinal rib running along at least a length of the first shell, first female posts and first male posts; the second shell comprising, on an inner surface thereof, a second longitudinal rib running along at least a length of the second shell, second female posts and second male posts; the first and second shells being connected together, along respective upper edges and bottom edges, each first male post engaging a corresponding second female post and each second male post engaging a corresponding first female post.

### CROSS REFERENCE TO RELATED APPLICATIONS

This application claims benefit, under 35 U.S.C. §119(e), of U.S. provisional application Ser. No. 62/363,903, filed on Jul. 19, 2016. All documents above are incorporated herein in their entirety by reference.

### FIELD OF THE INVENTION

The present invention relates to a handle for a tool.

### SUMMARY OF THE INVENTION

More specifically, in accordance with the present invention, there is provided a handle, comprising a first shell and a second shell, the first shell comprising, on an inner surface thereof, a first longitudinal rib running along at least a length of the first shell, first female posts and first male posts; the second shell comprising, on an inner surface thereof, a second longitudinal rib running along at least a length of the second shell, second female posts and second male posts; wherein the first and second shells are connected together, along respective upper edges and bottom edges, each first male post engaging a corresponding second female post and each second male post engaging a corresponding first female post.

There is further provided a handle, comprising a first shell and a second shell; the first shell comprising, on an inner surface thereof, a first longitudinal rib running generally parallel to a top edge of the first shell along at least a length of the first shell, a second longitudinal rib running generally parallel to a bottom edge of the first shell along at least a length of the first shell; and at least one of: i) first female posts and ii) first male posts; the second shell comprising, on an inner surface thereof, at least one of : i) second female posts and ii) second male posts; wherein the first and second shells are connected together, along respective upper edges and bottom edges thereof, each male post of a first one of the first and second shells engaging a corresponding female post of a second one of the first and second shells.

There is further provided a handle, comprising a first shell and a second shell, the first shell comprising, on an inner surface thereof, a first longitudinal rib running generally parallel to a top edge of the first shell along at least a length of the first shell, a second longitudinal rib running generally parallel to a bottom edge of the first shell along at least a length of the first shell; and at least a first one of: i) a female post and ii) a male post; and the second shell comprising, on an inner surface thereof, at least a second one of: i) a male post and ii) a female post; wherein the first and second shells are connected together, along respective upper edges and bottom edges, each male post engaging a corresponding female post.

There is further provided a method of fabrication of a handle, comprising providing a first shell comprising, on an inner surface thereof, a first longitudinal rib running along at least a length of the first shell; and at least a first one of: i) a female post and ii) a male post; providing a second shell comprising, on an inner surface thereof, a second longitudinal rib running along at least a length of the second shell; and at least a first one of: i) a male post and ii) a female post; and connecting the first and second shells together, along respective upper edges and bottom edges thereof, each male post engaging a corresponding female post.

There is further provided a hollow tool handle, comprising, on an inside thereof, a first generally longitudinal rib running along at least a length thereof at a first longitudinal edge thereof, a second generally longitudinal rib running along at least a length thereof at a second longitudinal edge thereof opposite said first longitudinal edge thereof; and transverse posts.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a first exploded view of a handle according to an embodiment of an aspect of the invention;

FIG. 2 is a second exploded view of the handle of FIG. 1;

FIG. 3 is a perspective view of the inner surface of a first shell of the handle of FIG. 1;

FIG. 4 is a perspective view of the inner surface of a second shell of the handle of FIG. 1;

FIG. 5 shows a detail of a handle where the two assembled shells are shown in transparency according to an embodiment of an aspect of the invention

FIG. 6A is a front perspective view of a shovel comprising a handle according to an embodiment of an aspect of the invention; and

FIG. 6B shows a detail of FIG. 6A.

### DESCRIPTION OF EMBODIMENTS OF THE INVENTION

The present invention is illustrated by the following non-limiting examples.

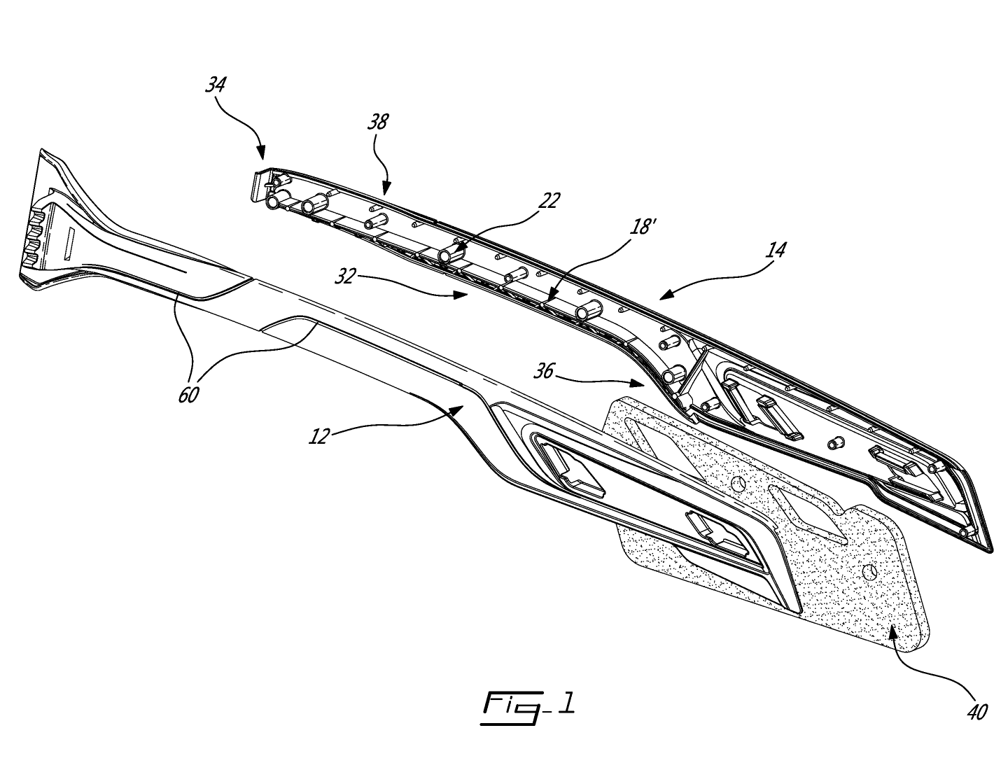

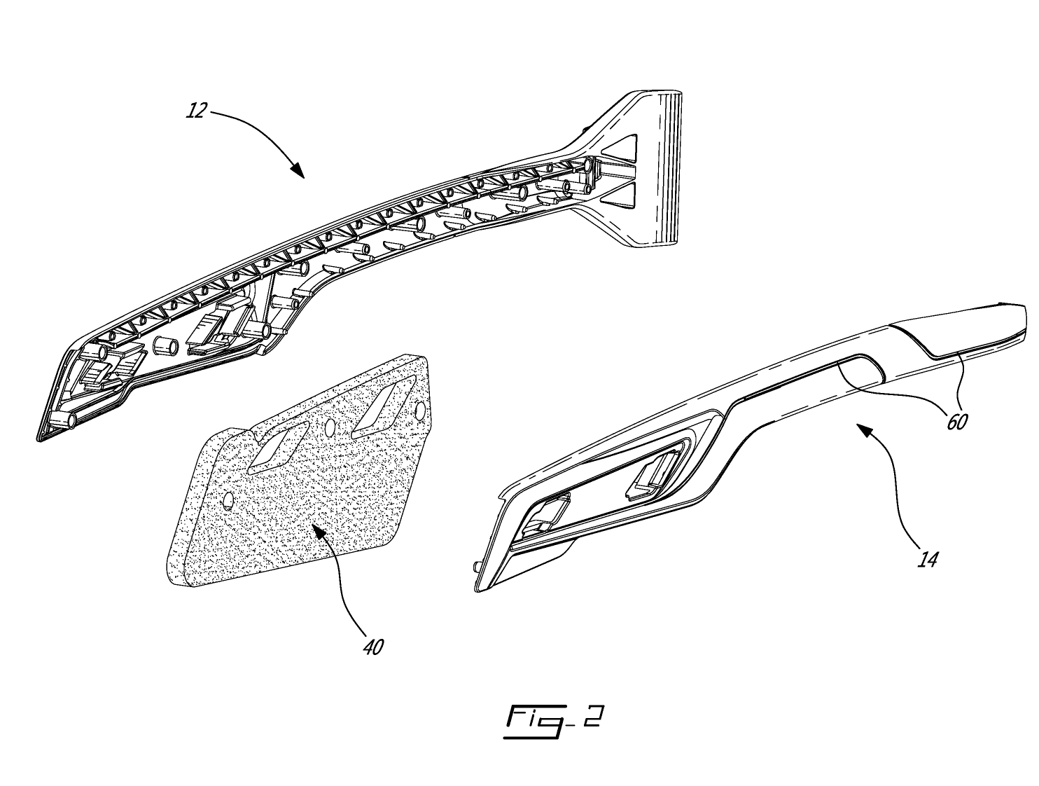

As illustrated for example in FIGS. 1 and 2 for example, a handle according to an embodiment of an aspect of the invention comprises a first shell 12 and a second shell 14.

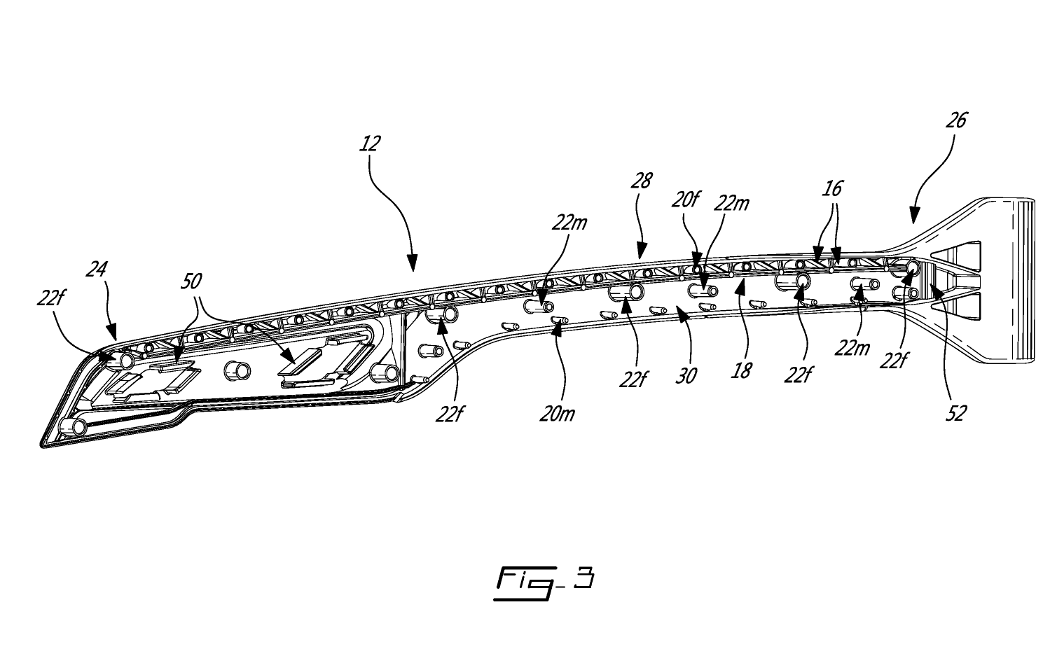

The first shell 12 is shown in FIG. 3 as an elongated member with a first end 24 and a second end 26. The first shell 12 comprises, on an inner surface thereof, a main longitudinal rib 18, running generally parallel to a top edge 28 of the first shell 12 along a at least a length of the first shell from the first end portion 24 to the second end portion 26.

The first shell 12 further comprises, on the inner surface thereof, reinforcing ribs 16 connecting the main longitudinal rib 18 to the inner surface of the first shell 12 and to the top edge 28 of the first shell 12.

The inner surface of the first shell 12 further comprises posts, extending generally perpendicularly therefrom; i.e. transverse posts. Female main posts 22f are shown connected to the main rib 18, at intervals along at least part of the length of the main rib 18 between the first end portion 24 to the second end portion 26, whereas male main posts 22m are offset from the main rib 18, along at least part of the length of the first shell 12.

Secondary male and female posts 20m and 20f respectively are positioned along the bottom edge 30 and the top edge 28 of the first shell 12 respectively. The secondary female posts 20f may be directly connected to the main rib 18 and to the top edge 28 of the shell 12. Alternatively, the secondary male and female posts 20m and 20f may be positioned at the edges 28, 30 of the shell 12.

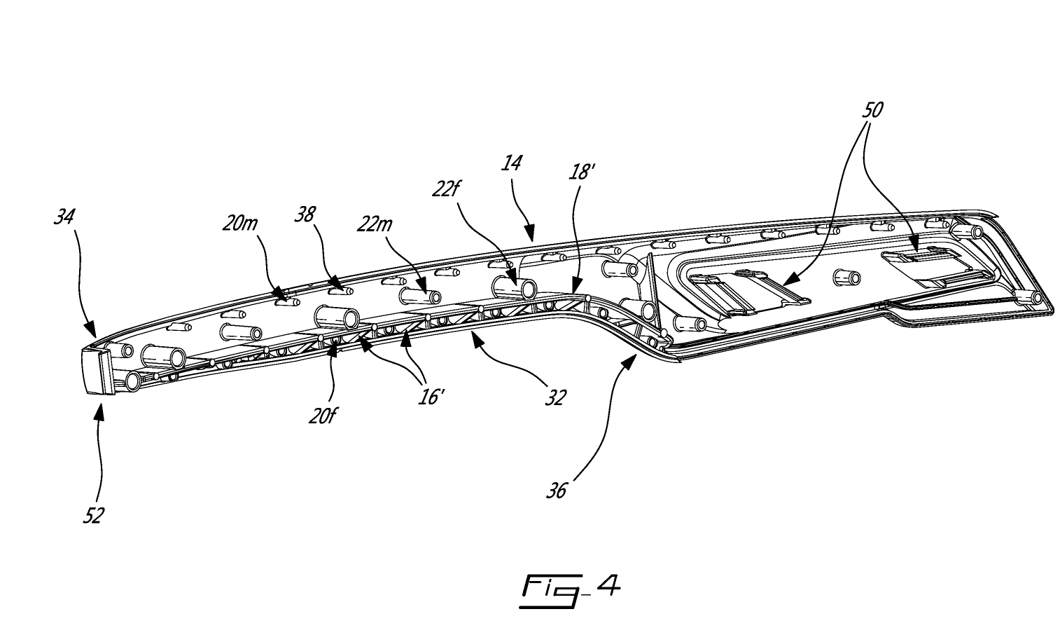

The second shell 14 is shown in FIG. 4 as an elongated member of a shape generally matching the shape of the first shell 12, with an inner surface thereof comprising a main rib 18′ running generally parallel to a bottom edge 32 of the second shell 14 along a at least a length of the second shell from a first end portion 34 to a second end portion 36 of the second shell 14. The second shell 14 further comprises, on the inner surface thereof, reinforcing ribs 16′ connecting the main longitudinal rib 18′ to the inner surface of the second shell 14 and to the bottom edge 32 of the second shell 14. The inner surface of the second shell 14 also comprises main posts 22 offset from the main rib 18′. Female main posts 22f are shown directly connected to the main rib 18′, whereas male main posts 22m are offset from the main rib 18′. Secondary posts 20 are positioned along the upper edge 38 of the second shell 14.

Alternatively, a first one of the shells 12, 14 may comprise both main ribs 18 and 18′ as well as the reinforcing ribs 16, 16′, the second one of the shells 12, 14 thus acting as a cover. Also, one of the shells 12, 14 may comprise only female post and the other one comprise corresponding male posts.

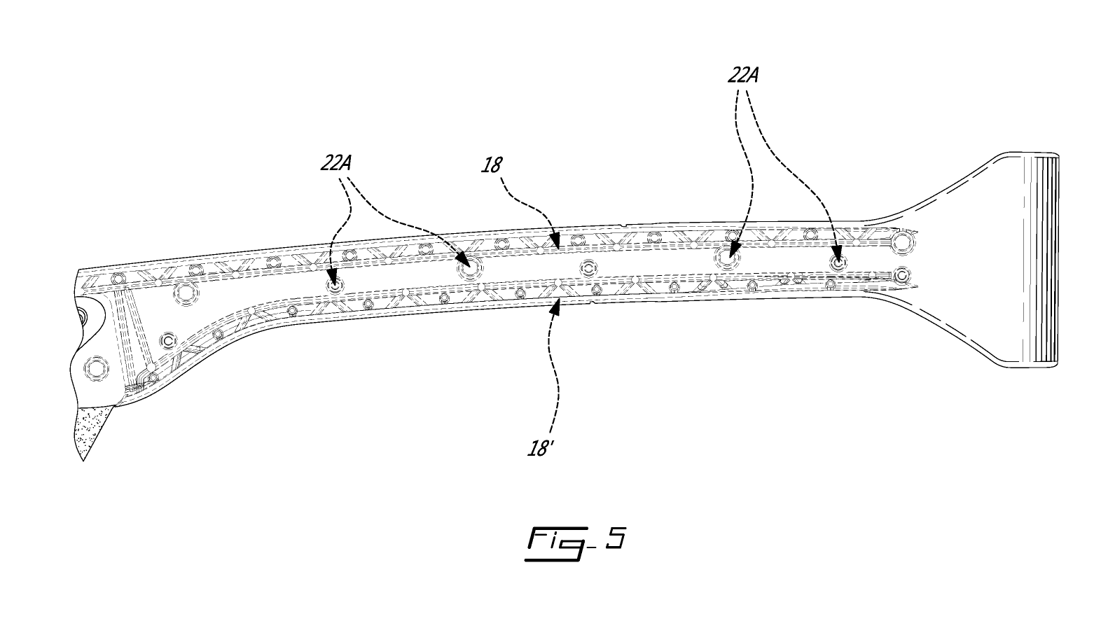

To form a handle, the first and second shells 12 and 14 are connected together, along their upper edges 28, 38, and their bottom edges 30, 32 respectively, each main male post 22m of a first one of the shells engaging a corresponding female main post 22f of the second one of the shells by interference fit, thus forming a strong transverse assembled post 22A and yielding a strong assembly of the two shells together, as seen for example in FIG. 5, where the two assembled shells are shown in transparency. By providing female main posts directly connected to the main ribs 18, 18′, the forces applied to the assembled posts 22A are distributed over the whole body of the shells, thereby preventing any single assembled post 22A from being torn away from the shells when submitted to a torsion or a flexion force. The secondary male and female posts prevent relative movement, such as any longitudinal movement under action of torsion or flexion on the handle, between the first and second shells once they are assembled together.

Thus the shells may be assembled and secured together by interference fit, for example press-fit, between male and female posts, and/or using hooks such as snap fits 50, 52 such as illustrated for example in FIGS. 3 and 4, or ultrasonic welding or glue between contacting surfaces of the two shells, or glue, or plastic heat staking for example.

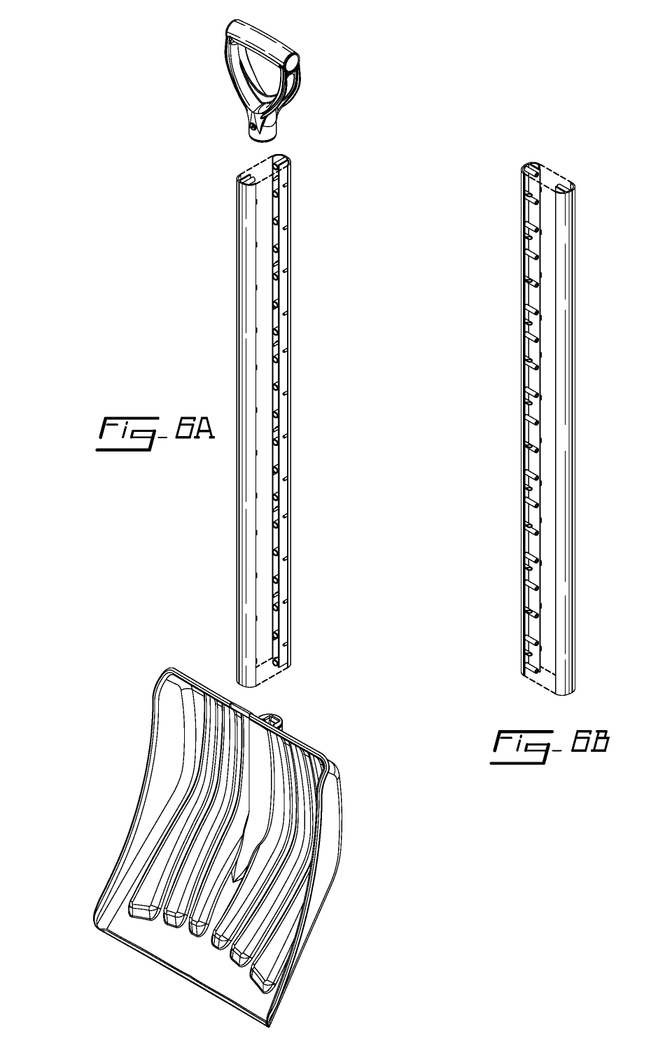

In the example illustrated of FIGS. 1 and 2, a foam 40 is secured in between the first and the second shells 12, 14 at the working end thereof, thereby forming a snow brush for example. FIG. 6 illustrates a shovel comprising a handle according to an embodiment of an aspect of the present invention.

The reinforcing ribs 16, 16′ prevent buckling of the main ribs 18, 18′ when the handle, once assembled as described hereinabove, is submitted to a bending moment. Moreover, these reinforcing ribs 16, 16′ form, together with the main ribs 18, 18′, an internal structure of the hollow handle for a distribution of the forces submitted to the handle to all parts thereof, the main ribs supporting the main posts, and the main posts and the reinforcing ribs supporting the main ribs. As can been seen in FIG. 5, the resulting handle has a balanced structure, with a generally longitudinal rib 18, 18′ running along each one of the top and bottom edge of the handle.

Both shells may be injection molded. In the case when the two shells are molded simultaneously in a same mold, providing that each shell comprises its main rib as described hereinabove allows balancing material injection as the amount of material for each shell is very similar. Moreover, molding the two shells simultaneously in a same mold allows a similar warping of the two pieces upon cooling down, which then makes them easier to assemble.

The shells may be injected molded in polyethylene, polypropylene, ABS, polycarbonate, Nylon, polyoxymethylene (POM), polymethyl methacrylate (PMMA) for example.

The present hollow handle is thus provided with an inner structure combining main ribs, reinforcing ribs and posts, for high mechanical resistance in torsion and flexion, while being light in weight.

The present hollow handle is thus provided with an outer surface free of ribs and uniform. This outer surface may then be texturized at will to increase comfort and control in use, such as non-slip property, and/or provided with a surface finish 60 as shown for example in FIGS. 1 and 2.

As people in the art would appreciate, the present handle may by used as a part of, as a whole of, a handle or a grip of a tool such as a shovel (see FIGS. 6), a rake, a snow shovel, a snow broom or brush, a broom, a push broom, a scraper, a gardening tool etc...

The scope of the claims should not be limited by the embodiments set forth in the examples, but should be given the broadest interpretation consistent with the description as a whole.

1. A handle, comprising:
a first shell; and
a second shell;
said first shell comprising, on an inner surface thereof, a first longitudinal rib running along at least a length of the first shell, first female posts and first male posts;
said second shell comprising, on an inner surface thereof, a second longitudinal rib running along at least a length of the second shell, second female posts and second male posts;
wherein said first and second shells are connected together, along respective upper edges and bottom edges, each first male post engaging a corresponding second female post and each second male post engaging a corresponding first female post

2. The handle of claim 1, wherein said first longitudinal rib runs generally parallel to a top edge of the first shell and said second longitudinal rib runs generally parallel to a bottom edge of the second shell.

3. The handle of claim 1, wherein said first shell comprises, on the inner surface thereof, ribs connecting the first longitudinal rib to the inner surface of the first shell and to the top edge of the first shell.

4. The handle of claim 1, wherein said second shell comprises, on the inner surface thereof, ribs connecting the second longitudinal rib to the inner surface of the second shell and to the bottom edge of the second shell.

5. The handle of claim 1, wherein said first shell comprises, on the inner surface thereof, ribs connecting the first longitudinal rib to the inner surface of the first shell and to the top edge of the first shell, and said second shell comprises, on the inner surface thereof, ribs connecting the second longitudinal rib to the inner surface of the second shell and to the bottom edge of the second shell.

6. The handle of claim 1, wherein at least one of: i) said first female posts comprise at least one female post connected to the first longitudinal rib; and ii) said second female posts comprise at least one female post connected to the second longitudinal rib.

7. The handle of claim 1, wherein at least one of: i) said first male posts are offset from the first longitudinal rib; and ii) said second male posts are offset from the second longitudinal rib.

8. The handle of claim 1, wherein said first female posts comprise at least one female post positioned along the bottom edge of the first shell and said first male post comprise at least one male post positioned along the top edge of the first shell; and said second female posts comprise at least one female post positioned along the bottom edge of the second shell and said second male post comprise at least one male post positioned along the bottom edge of the second shell.

9. A handle, comprising:
a first shell;
a second shell; and
said first shell comprising, on an inner surface thereof, a first longitudinal rib running generally parallel to a top edge of the first shell along at least a length of the first shell, a second longitudinal rib running generally parallel to a bottom edge of the first shell along at least a length of the first shell; and at least one of: i) first female posts and ii) first male posts; and
said second shell comprising, on an inner surface thereof, at least one of: i) second female posts and ii) second male posts;
wherein said first and second shells are connected together, along respective upper edges and bottom edges thereof, each male post of a first one of said first and second shells engaging a corresponding female post of a second one of said first and second shells.

10. The handle of claim 9, wherein said first female posts comprises female posts connected to the first longitudinal rib and female posts connected to the second longitudinal rib.

11. The handle of claim 9, wherein said first female posts comprises female posts connected to the first longitudinal rib and female posts connected to the second longitudinal rib, and said first shell comprises, on the inner surface thereof, at least one of : i) ribs connecting the first longitudinal rib to the inner surface of the first shell and to the top edge of the first shell; and ii) ribs connecting the second longitudinal rib to the inner surface of the first shell and to the bottom edge of the first shell.

12. A method of fabrication of a handle, comprising:
providing a first shell comprising, on an inner surface thereof, a first longitudinal rib running along at least a length of the first shell; and at least a first one of: i) a female post and ii) a male post;
providing a second shell comprising, on an inner surface thereof, a second longitudinal rib running along at least a length of the second shell; and at least a first one of: i) a male post and ii) a female post; and
connecting the first and second shells together, along respective upper edges and bottom edges thereof, each male post engaging a corresponding female post.

13. A hollow tool handle, comprising, on an inside thereof, a first generally longitudinal rib running along at least a length thereof at a first longitudinal edge thereof, a second generally longitudinal rib running along at least a length thereof at a second longitudinal edge thereof opposite said first longitudinal edge thereof; and transverse posts.

14. A tool comprising the handle of claim 1.

15. A tool comprising the handle of 13.
